(19) United States
(12) Patent Application Publication
(10) Pub. No.: US 2006/0136906 A1
(43) Pub. Date: Jun. 22, 2006

(54) Software product installation facilitation

(75) Inventors: Aidan T. Hughes, Bellevue, WA (US); James A. Bennett, Duvall, WA (US); Scott E. Kurtzeborn, Redmond, WA (US); Terri V. Cheff-Goldade, Milltown, MT (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/018,937

(22) Filed: Dec. 20, 2004

(51) Int. Cl. G06F 9/445

(52) U.S. Cl. 717/174

(57) ABSTRACT

Described herein are one or more implementations for facilitating installation of software products. In at least one implementation, one or more installation databases (e.g., MSI databases) are stored on the computer-readable media (e.g., a CD-ROM or hard disk). The installation databases include data configured to be loaded onto a computing system when a software product is installed onto that computing system. Also stored on that media is one or more executable installation components (e.g., MSI installer) that, when executed, directs installation of the software product from the one or more installation databases. With this implementation, components of the one or more installation databases are stored on the computer-readable media in a defined hierarchical directory structure, which includes, at least, a root and one sub-level, the sub-level comprising, at least, two sub-directories

### TECHNICAL FIELD

This invention generally relates to technology for facilitating installation of software products.

### BACKGROUND

A “software product” is typically installed on a computing system via portable computer-readable media (e.g., a CD-ROM, DVD-ROM, floppy disk, etc.) or via a computer communications network (e.g., a Local Area Network (LAN), Wide Area Network (WAN), Internet, intranet, extranet, point-to-point communications, etc.).

A software product is typically manifested by a bundle including installation databases and installation programs on one or more computer-readable media (portable media or via a network) for installation on a computing system. This installation manifestation is bundled so that it provides for installation of the software product on to the computing system from that product's installation media.

For example, the Microsoft® Word® word processing product is a software product (more specifically, it is an application). The installation bundle for this particular product consists of an installation program and one or more installation databases.

In this example, the installation program is the Microsoft® Windows® Installer software-installation product. The Windows® Installer manages the installation of software products (e.g., the Microsoft® Word® word processing product) and/or removal, updating, and/or modification of already-installed software products by applying a set of centrally defined setup rules during the installation process. These setup rules define the installation and configuration of the installed application.

The installation database for this particular product is used to hold information regarding the setup and installation of this particular product. That includes the aforementioned setup rules. The installation database is composed of so-called “MSI files.” Thus, the installation is loosely called a “MSI database” and the Windows® Installer is often loosely called a “MSI installer.”

Once installed, the software product has a manifestation that allows it to be functional and/or useful on the computer. Generally, examples of functional and/or useful manifestations of software products are applications, operating systems, drivers, etc.

Specific examples of software products include the Microsoft® Word® word processing product, the Microsoft® Excel® spreadsheet product, the Microsoft® FrontPage® web publisher product, the Microsoft® Publisher® desktop publisher product, Microsoft® Access® database product, Microsoft® Encarta® electronic encyclopedia product, Microsoft® Money® personal financial product, and Microsoft® Visio® computer-aided drafting product. Of course, these examples are provided for the purpose of explanation and not for the purpose of limitation.

In a small-scale network, it is common for a network administrator (“net-admin”) to personally visit each physical computer on the network when installing new software products or upgrading already installed products. Typically, a net-admin does this by personally inserting a portable computer-readable medium (e.g., a CD-ROM) in the drive of each computer and installing the software.

However, in a medium-to-large scale mutli-user network environment (herein, an “enterprise network”), it is quite difficult for the net-admins to personally visit each physical computer on the network for installation and upgrade purposes. Instead, enterprise networks often utilize a network-accessible share-point for each software product. This way, each user may access the appropriate installation software on the network-accessible share-point.

FIG. 1 illustrates this conventional approach. A network-coupled software installation server 110 is shown with its network-shared hard drive 120. The distinctly different software products 112, 114, 116 are named “A”, “B”, and “C”, respectively.

While these products may be nearly any distinct product, we will assume, for this example, that software product A 112 is Microsoft® Office® 2002 Professional suite of office productivity products, software product B 114 is Microsoft® Publisher® desktop publishing product, and software product C 116 is Microsoft® Visio® computer-aided drafting product.

As represented by the arrows in FIG. 1, the software installation components of each of these products are loaded (e.g., copied) from their original computer-readable media source (e.g., CD-ROMs or floppy disks) onto the server 110. More specifically, the software installation bundle of each product is loaded into their own specific “share-point” on the shared hard drive 120 of the server 110. For example, the MSI installer and MSI database for Microsoft® Office® 2002 is loaded onto share-point 122 on the shared hard drive 120 of the server 110.

As shown in FIG. 1, product A is loaded at share-point 122, product B is loaded at share-point 124, and product C is loaded at share-point 126. A share-point may be, for example, a shareable storage resource on the hard drive 120 that is distinct from other share-points. This is often accomplished by giving each share-point its own shared “folder” (e.g., sub-folder, directory, sub-directory) in the hierarchical organization of the shared hard drive 120. These share-points are separate in that the content of one is not intermixed with the content of the other and in that, each is separately accessible from other share-points.

As shown in FIG. 1, network workstations 140, 142, and 144 are coupled to a communications network 130 (e.g., the network or a LAN) to which the server 110 is also coupled. If, for example, a user on workstation 140 wants to install software product C onto her workstation, this user connects to distinct share-point 126 for the installation bundle for this software product. From that share-point, the user installs software product C.

Likewise, assume that a user on workstation 142 wants to install both software products A and B onto her workstation. This user connects to one of the distinct share-points (either 122 or 124) for the installation bundle for either of the software products A or B. From that share-point, the user installs one of the software products. Next, the user connects to the other distinct share-point to install the other software product. Then the user installs this other software product from this other share-point.

For this example, assume that software product A 112 was Microsoft® Office® 2002 Professional suite of office productivity products, software product B 114 was Microsoft® Publisher® desktop publishing product, and software product C 116 was Microsoft® Visio® computer aided drafting product. However, note that these software products may be simply different variations or customizations of the same software product. In other words, these maybe viewed as products A₁, A₂, and A₃ rather than A, B, and C. In this example, product A₁ may be Microsoft® Office® suite of office productivity products with the installed language of English, product A₂ may be Microsoft® Offices suite of office productivity products with the installed language of German, and product A₃ may be Microsoft® Office® suite of office productivity products with the installed language of Mandarin Chinese.

In an enterprise-network, a net-admin will direct those that speak English to the share-point of the English version, those that speak German to the German share-point, and those that speak Mandarin to the Mandarin share-point.

Therefore, it is conventional for a net-admin to create an installation share-point for each software product and, indeed, it is common for each variation and customization of a software product to have its own installation share-point.

Consequently, the net-admin spends a great deal of time generating multiple distinct share points for each product and each variant of that product which may be utilized in its enterprise network. Furthermore, the net-admins must adequately direct users to install the particular products and/or variants that the users should have.

### SUMMARY

Described herein are one or more implementations for facilitating installation of software products. In at least one implementation, one or more installation databases (e.g., MSI databases) are stored on the computer-readable media (e.g., a CD-ROM or hard disk). The installation databases include data configured to be loaded onto a computing system when a software product is installed onto that computing system.

Also stored on that media is one or more executable installation components (e.g., MSI installer) that, when executed, directs installation of the software product from the one or more installation databases. With this implementation, components of the one or more installation databases are stored on the computer-readable media in a defined hierarchical directory structure, which includes, at least, a root and one sub-level, the sub-level comprising, at least, two sub-directories.

### BRIEF DESCRIPTION OF THE DRAWINGS

The same numbers are used throughout the drawings to reference like elements and features.

FIG. 1 shows an operational scenario in a networking environment that illustrates some background aspects of at least one implementation described herein.

FIG. 2 shows an operational scenario in accordance with at least one implementation described herein.

FIG. 3 illustrates a flow diagram showing a methodological implementation described herein.

FIG. 4 is an example of a computing operating environment capable of (wholly or partially) implementing at least one embodiment described herein.

### DETAILED DESCRIPTION

The following description sets forth techniques facilitating installation of software products from a common installation share-point on a communications network.

Exemplary Software-Product Installation Facilitator

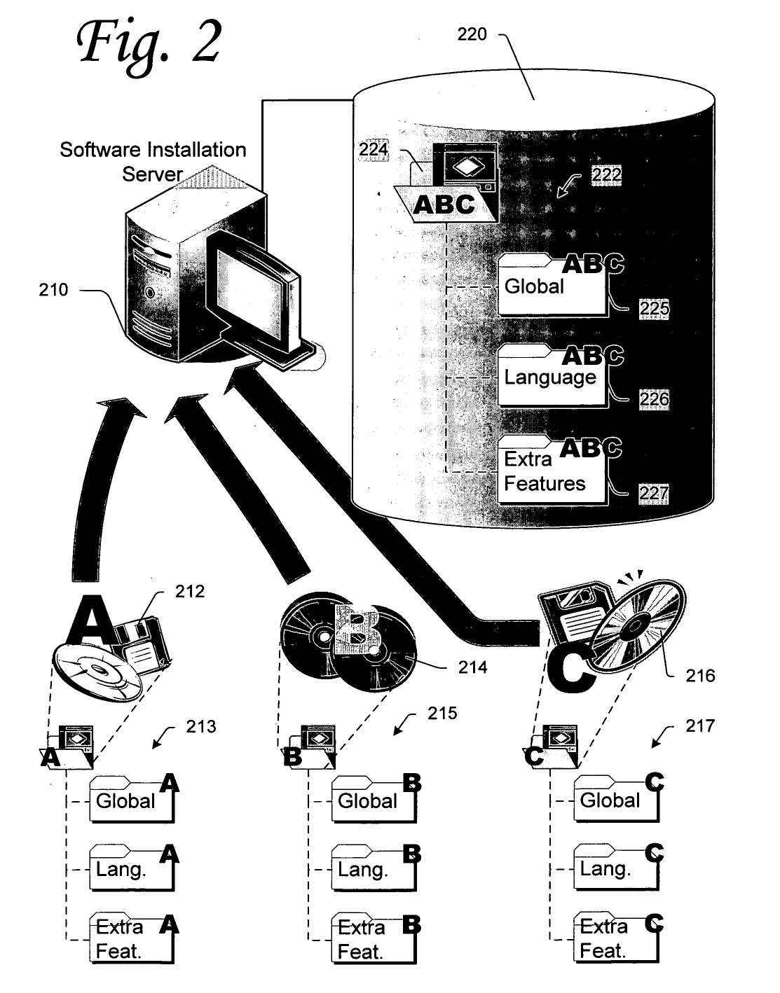

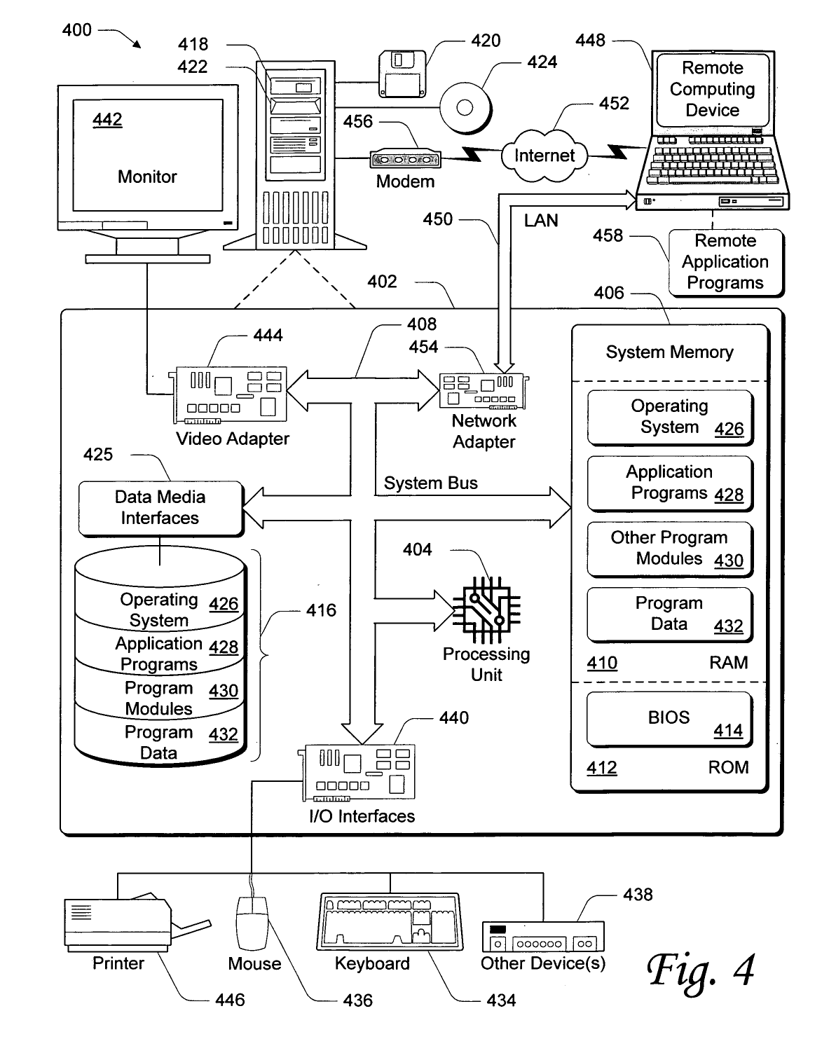

FIG. 2 illustrates an implementation that facilitates the installation of software products from a common installation share-point on a communications network. The illustrated software-product installation facilitator itself is, for example, a computer system (such as is depicted in FIG. 4), or a part of that system, that stores or utilizes the storage of the installation components of software product on its installation computer-readable media.

FIG. 2 shows a network-coupled software installation server 210, which is shown with its network-shared hard drive 220. Distinctly different software products 212, 214, 216 are named “A”, “B”, and “C”, respectively. As shown in FIG. 2, each has its own original installation computer-readable media. For example, software product A 212 is depicted utilizing both a CD-ROM and a floppy diskette media.

The software installation components (e.g., executables, non-executable data, and databases) are organized on the media with a pre-defined hierarchical directory structure. For example, software product A 212 has its installation components arranged in a hierarchical directory structure like that shown in at 213.

Within that structure, a universal installation program (e.g., “setup.exe” or a so-called “MSI installer”) is stored at the root of the hierarchical directory structure. There is also a metadata file in the root directory that describes the content of the software installation components. This metadata file may have a hierarchical format, like, for example, eXtensible Mark-up Language (XML).

Under the root, there are multiple sub-directories. In the example illustrated at 213, there are three sub-directories which are labeled “Global,” “Language,” “Extra Features.” Of course, just three sub-directories are shown and described here in this example. Other implementations of software-installation facilitation may include more sub-directories and, indeed, each of the above-listed example sub-directories may be further divided into multiple different sub-directories or sub-sub-directories.

In this example, the “Global” sub-directory contains one or more databases having the basic or fundamental installation software components of the software product. In other words, some or all of these software components would be installed for each installation of this software component. Some or all of these software components are installed regardless of which language (or other cosmetic customization) is selected.

The “Global” (e.g., operationally fundamental) sub-directory includes one or more installation databases (e.g., MSI databases) having software installation components (e.g., files and data) which, when installed on the computer, are operationally fundamental for the software product. Examples of these components include a main executable (e.g., winword.exe and setlang.exe), dynamic link libraries (e.g., mso.dll), and any language-independent executables and DLLs (e.g., “exe” and “dll”).

In this example, the “Language” sub-directory contains the language customization installation software components of the software product. In other words, a language-specific set of software components would be installed for each language selected during the installation of this software component. While the fundamental operation and function of the software product is handled by the “Global” components, these “Language” components customize the linguistic appearance/interface for the user.

The “Language” (e.g., appearance-based installation-customization) includes one or more installation databases (e.g., MSI databases) having software installation components (e.g., files and data) configured for appearance-based installation-customization. These installation components are loaded onto the computing system during installation of the software product in response to selection of one or more appearance-based customization options. Examples of these components include language specific templates, localized string resources for displaying dialogues in different languages. Components might includes language or appearance specific DLLs (e.g., wwint.dll, slintl.dll, msointl.dll).

In this example, the “Extra Features” sub-directory contains one or more installation databases (e.g., MSI databases) having software installation components (e.g., files and data) for additional functional features of the product. In other words, a set of software components would be installed for each additional feature selected during the installation of this software component. While the fundamental operation and function of the software product is handled by the “Global” components, these “Extra Features” components provide additional functionality over and above the basic functionality.

The installation components of the “Extra Features” (e.g., functional-based installation-customization) are loaded onto the computing system during installation of the software product in response to selection of one or more functional-based customization options. Examples of these components include proofing tools, add-on's, plus packs, etc. The installation of “Extra Features” allows for the adding of packages later without having to redefine (i.e., patch) part of an existing software product. Proofing tools include, for example, spelling and grammar checkers, hyphenators, style checkers, customized dictionaries, translation tools, fonts, etc. for a specific language.

The “Language” and “Extra Features” sub-folders are so labeled here because that is what they are called in at least one implementation. These may, of course, have other labels. Indeed, the “Language” sub-folder may be generically called the “cosmetic customization” sub-folder because it allows for the customization of the appearance of the software product without substantially affecting the functionality. The “Extra Features” sub-directory may be generically called the “functionality customization” because it modifies existing functionality or provides additional functionality.

Software products B and C (214 and 216) have their one or more installation databases (e.g., MSI databases) arranged in an identical hierarchical directory structure, as shown at 215 and 217. Furthermore, the naming conventions of the components (e.g., files and data) of the installation databases and their arrangement in that hierarchical directory structure ensures that there will be no conflicts when the components from different products are stored at a universal installation share-point. Conflict, herein, primarily means that two or more components for different products will not “over-write” or attempt to “over-write” each other when stored at the same location (e.g., universal installation share-point).

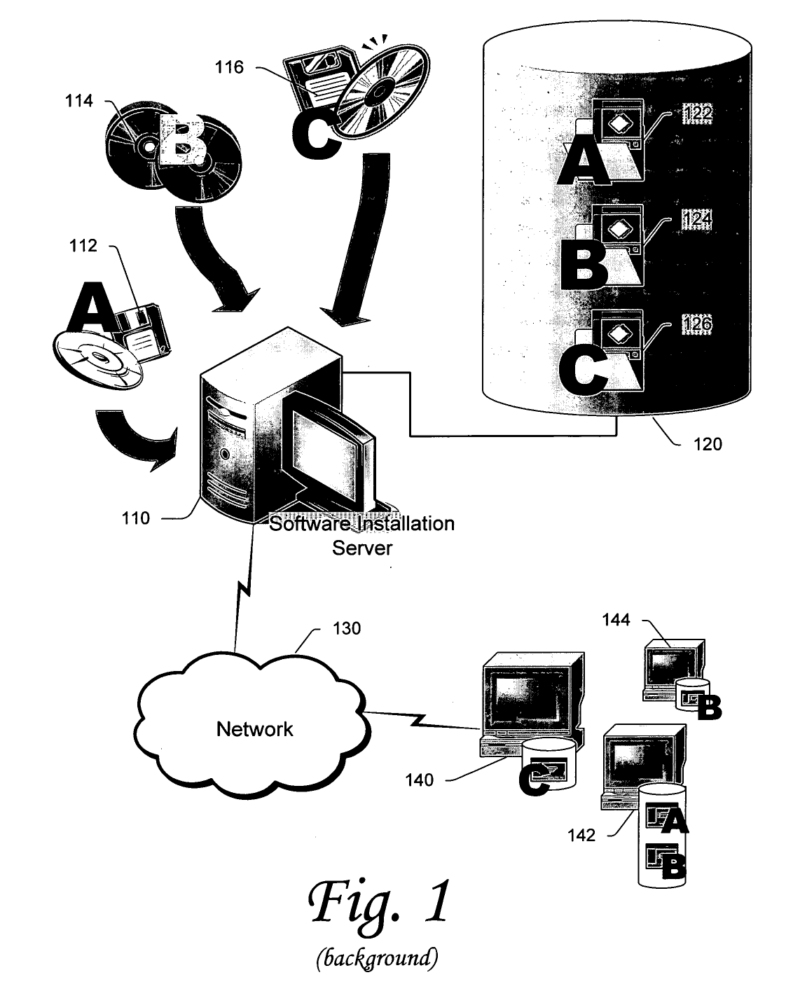

As represented by the arrows in FIG. 2, the installation bundle of each of these products (A, B, and C) are loaded (e.g., copied) from their original computer-readable media source (e.g., CD-ROMs or floppy disks) onto the server 210. However, unlike the conventional approach (shown in FIG. 1), the installation bundle of all of these products are loaded into one common or universal “share-point” 222 on the shared hard drive 220 of the server 210.

In general, a share-point may be, for example, a shareable storage resource on the hard drive 220 that is distinct from other share-points. This is often accomplished by giving each share-point its own shared “folder” (e.g., sub-folder, directory, sub-directory) in an hierarchical organization of the shared hard drive 220.

With conventional share-points (like 122 in FIG. 1), each share-point is distinct in that the content of one is not intermixed with the content of the other and in that each is separately accessible from other share-points. However, with the universal share-point 222, the installation bundle of multiple distinct software products (e.g., A, B, and C) are, indeed, intermixed with the each other. In other words, a user may install multiple distinct software products from one universal share-point.

The universal share-point 222 in FIG. 2 shows the same hierarchical directory structure for installation bundles of the multiple distinct software products A, B, and C (as shown in FIG. 2). Within that structure, a universal installation program is stored at the root 224 of the hierarchical directory structure of the universal share-point 222 in FIG. 2. In the example illustrated at 222, there are three sub-directories which are labeled “Global” 225, “Language” 226, “Extra Features” 227.

Indeed, the standardized hierarchical directory structure allows for the unique installation bundle of each of the multiple distinct software products A, B, and C to be loaded onto the same share-point without conflict. The “ABC” label for each of the sub-directories of the universal share-point 222 indicates the installation bundles of all three software products A, B, and C cohabitate the same sub-directories.

The universal installation program (e.g., “setup.exe”) stored at the root 224 of the hierarchical directory of the universal share-point 222 is the same universal installation program stored at the root of the original computer-readable source of the multiple distinct software products A, B, and C (as shown in FIG. 2). Since each software product has the same universal installation program, there is no conflict when each is loaded into the same location (e.g., the root 224) of the universal share-point 222.

The universal installation program is designed to be used as the one and only installation program on the original computer-readable source of each of multiple distinct software products A, B, and C. It is also designed to be used as the universal installation program on a universal share-point. The universal installation program examines the contents in the hierarchical directory structure of the universal share-point and provides the user with installation options based upon the available choices found in that the universal share-point, such as share-point 222.

The universal installation program (named, for example, “setup.exe”) is a common installation executable program for a collection of compatible installable software products. The universal installation program searches the universal installation share-point for appropriate source installation data (i.e., installation bundles). Its user-interface provides a list of available software products to the user. This is list is based upon what exists in the universal installation share-point.

Although it is not shown in FIG. 2, multiple network workstations (like workstations 140, 142, and 144 shown in FIG. 1) are coupled to a communications network (like network 130 in FIG. 1) to which the server 210 is also coupled. If, for example, a user on network-coupled workstation wants to install software product C onto her workstation, this user connects to the universal share-point 222 and runs a universal installation program on the root 224 of the share-point 222. The universal installation program will provide the user the option to install software product C because it is one of the software products which has its installation components on the universal share-point 222.

Furthermore, the user at one of the workstations may customize the installation of software product C by selecting one or more specific language amongst those available at the “Language” sub-directory 226 at the universal share-point 222. Moreover, the user at the same workstations may further customize the installation of software product C by selecting one or more specific additional functions and features amongst those available at the “Extra Features” sub-directory 227 at the universal share-point 222.

Similarly, assume that a user on another network-coupled workstation wants to install both software products A and B onto her workstation. This user connects to the universal share-point 222 and runs the universal installation program. During the installation, the user selects to install both software products A and B.

With the conventional approach, the net-admin had to create a different installation share-point for each different combination of available software products, language, and extra features. However, with the exemplary software-product installation facilitation, instead of creating dozens and maybe even hundreds of different installation share-points for each unique combination of products and its cosmetic and functional customization, the net-admin only needs to create one universal share-point for multiple compatible software products.

Methodological Implementations

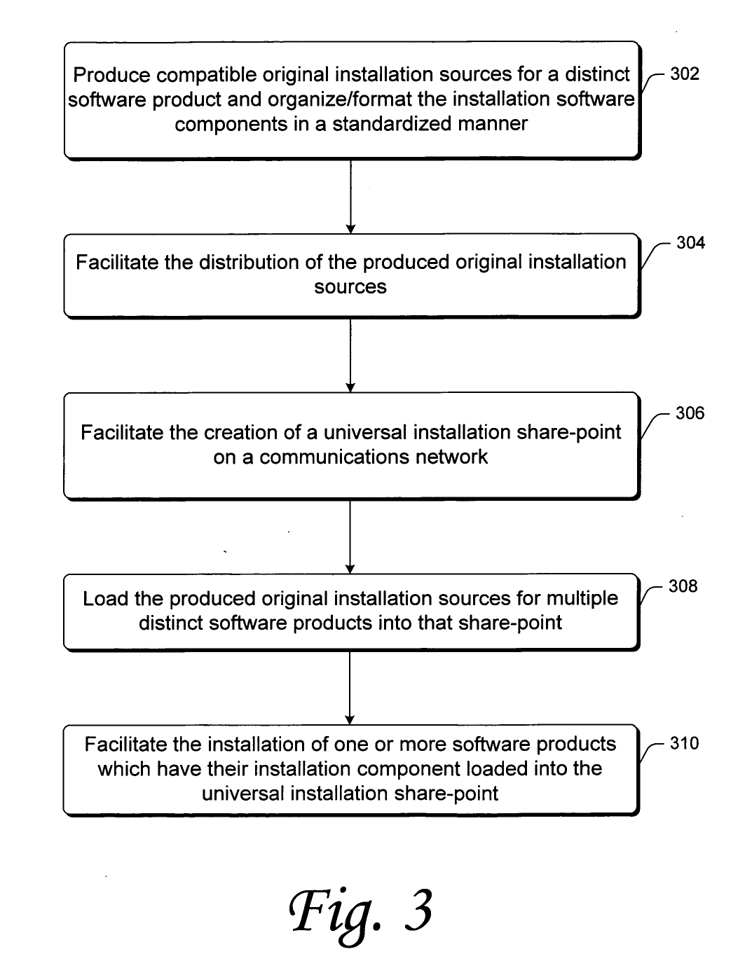

FIG. 3 shows a methodological implementation in accordance with the exemplary software-product installation facilitation. This methodological implementation may be performed in software, hardware, or a combination thereof. For ease of understanding, the method steps are delineated as separate steps; however, these separately delineated steps should not be construed as necessarily order dependent in their performance.

At 302 of FIG. 3, a suitable computer system implementing the exemplary software-product installation facilitation (such as that of a computing environment 400 of FIG. 4) produces one or more compatible original installation sources (e.g., installation bundles) on one or more computer-readable media for a distinct software product. For example, it might produce a CD-ROM for software product “A” 212, which might be, for example, Microsoft® Office® 2003 Professional® suite of office productivity products.

When producing this media, it organizes and formats the installation bundle contents (e.g., installation executables, data, and databases) in accordance with a pre-defined hierarchical directory structure. For example, software product A 212 has its installation bundle contents arranged in a hierarchical directory structure like that shown in at 213. Media organized in a common organizational structure represents compatible media.

The contents on each of the produced original installation sources are arranged in an identical hierarchical directory structure, as shown at 215 and 217. This foresight in the arrangement and formatting of the structure and contents aids in the loading of the installation bundle contents of multiple distinct software products into a universal installation share-point.

The naming conventions of the components of the installation bundle contents and the arrangement of the components of the installation bundle contents in that hierarchical directory structure ensures that there will be no conflicts when the components from different products are stored at a universal installation share-point.

At 304, this block includes facilitating the distribution of the produced original installation sources (e.g., installation bundles). Such a distribution may be accomplished via physical mechanisms, such as, for example, shipment and delivery of CD-ROM disks. Such a distribution may be accomplished via non-physical mechanisms, such as, for example, electronic transmission of executables and data via a communications network.

At 306 of FIG. 3, this block includes facilitating the creation of a universal installation share-point (such as the universal share-point 222) on a communications network and loads, at 308, the produced original installation sources for multiple distinct software products into that share-point. The loading occurs without conflict amongst the software installation components.

These steps (306 and 308) may be accomplished (by way of example only and not by limitation) by designating a shared sub-directory on a server to be the universal installation share-point. Then a net-admin may simply copy the contents of each compatible software installation source (e.g., a CD-ROM) into this designated universal installation share-point. The “copying” may be accomplished by using a graphical user interface technique called “drag-and-drop,” which is a technique that is well known to those of skill in the art.

At 310, a computer system implementing the exemplary software-product installation facilitation facilitates the installation of one or more software products which have their installation bundle loaded into a universal installation share-point (such as the universal share-point 222).

This step (310) may be accomplished (by way of example only and not by limitation) by the user executing a universal installation program (e.g., “setup.exe”) located at the root of the hierarchical directory structure at the universal installation share-point.

Exemplary Computing System and Environment

FIG. 4 illustrates an example of a suitable computing environment 400 within which an exemplary software-product installation facilitation, as described herein, may be implemented (either fully or partially). The computing environment 400 may be utilized in the computer and network architectures described herein.

The exemplary computing environment 400 is only one example of a computing environment and is not intended to suggest any limitation as to the scope of use or functionality of the computer and network architectures. Neither should the computing environment 400 be interpreted as having any dependency or requirement relating to any one or combination of components illustrated in the exemplary computing environment 400.

The exemplary software-product installation facilitation may be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, personal digital assistants (PDA), appliances, special-purpose electronics (e.g., a DVD player), programmable consumer electronics, network PCs, minicomputers, mainframe computers, distributed computing environments that include any of the above systems or devices, and the like.

The exemplary software-product installation facilitation may be described in the general context of computer-executabe instructions, such as program modules, being executed by a computer. Generally, program modules include routines, programs, objects, components, data structures, etc. that perform particular tasks or implement particular abstract data types. The exemplary software-product installation facilitation may also be practiced in distributed computing environments where tasks are performed by remote processing devices that are linked through a communications network. In a distributed computing environment, program modules may be located in both local and remote computer storage media including memory storage devices.

The computing environment 400 includes a general-purpose computing device in the form of a computer 402. The components of computer 402 may include, but are not limited to, one or more processors or processing units 404, a system memory 406, and a system bus 408 that couples various system components, including the processor 404, to the system memory 406.

The system bus 408 represents one or more of any of several types of bus structures, including a memory bus or memory controller, a peripheral bus, an accelerated graphics port, and a processor or local bus using any of a variety of bus architectures. By way of example, such architectures can include a CardBus, Personal Computer Memory Card International Association (PCMCIA), Accelerated Graphics Port (AGP), Small Computer System Interface (SCSI), Universal Serial Bus (USB), IEEE 1394, a Video Electronics Standards Association (VESA) local bus, and a Peripheral Component Interconnects (PCI) bus, also known as a Mezzanine bus.

Computer 402 typically includes a variety of computer-readable media. Such media may be any available media that is accessible by computer 402 and includes both volatile and non-volatile media, removable and non-removable media.

The system memory 406 includes computer-readable media in the form of volatile memory, such as random access memory (RAM) 410, and/or non-volatile memory, such as read only memory (ROM) 412. A basic input/output system (BIOS) 414, containing the basic routines that help to transfer information between elements within computer 402, such as during start-up, is stored in ROM 412. RAM 410 typically contains data and/or program modules that are immediately accessible to and/or presently operated on by the processing unit 404.

Computer 402 may also include other removable/non-removable, volatile/non-volatile computer storage media. By way of example, FIG. 4 illustrates a hard disk drive 416 for reading from and writing to a non-removable, non-volatile magnetic media (not shown), a magnetic disk drive 418 for reading from and writing to a removable, non-volatile magnetic disk 420 (e.g., a “floppy disk”), and an optical disk drive 422 for reading from and/or writing to a removable, non-volatile optical disk 424 such as a CD-ROM, DVD-ROM, or other optical media. The hard disk drive 416, magnetic disk drive 418, and optical disk drive 422 are each connected to the system bus 408 by one or more data media interfaces 425. Alternatively, the hard disk drive 416, magnetic disk drive 418, and optical disk drive 422 may be connected to the system bus 408 by one or more interfaces (not shown).

The disk drives and their associated computer-readable media provide non-volatile storage of computer readable instructions, data structures, program modules, and other data for computer 402. Although the example illustrates a hard disk 416, a removable magnetic disk 420, and a removable optical disk 424, it is to be appreciated that other types of computer-readable media, which may store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, may also be utilized to implement the exemplary computing system and environment.

Any number of program modules may be stored on the hard disk 416 magnetic disk 420, optical disk 424, ROM 412, and/or RAM 410, including, by way of example, an operating system 426, one or more application programs 428, other program modules 430, and program data 432.

A user may enter commands and information into computer 402 via input devices such as a keyboard 434 and a pointing device 436 (e.g., a “mouse”). Other input devices 438 (not shown specifically) may include a microphone, joystick, game pad, satellite dish, serial port, scanner, and/or the like. These and other input devices are connected to the processing unit 404 via input/output interfaces 440 that are coupled to the system bus 408, but may be connected by other interface and bus structures, such as a parallel port, game port, or a universal serial bus (USB).

A monitor 442 or other type of display device may also be connected to the system bus 408 via an interface, such as a video adapter 444. In addition to the monitor 442, other output peripheral devices may include components, such as speakers (not shown) and a printer 446, which may be connected to computer 402 via the input/output interfaces 440.

Computer 402 may operate in a networked environment using logical connections to one or more remote computers, such as a remote computing device 448. By way of example, the remote computing device 448 may be a personal computer, a portable computer, a server, a router, a network computer, a peer device or other common network node, and the like. The remote computing device 448 is illustrated as a portable computer that may include many or all of the elements and features described herein, relative to computer 402.

Logical connections between computer 402 and the remote computer 448 are depicted as a local area network (LAN) 450 and a general wide area network (WAN) 452. Such networking environments are commonplace in offices, enterprise-wide computer networks, intranets, and the Internet. Such networking environments may be wired or wireless.

When implemented in a LAN networking environment, the computer 402 is connected to a local network 450 via a network interface or adapter 454. When implemented in a WAN networking environment, the computer 402 typically includes a modem 456 or other means for establishing communications over the wide network 452. The modem 456, which may be internal or external to computer 402, may be connected to the system bus 408 via the input/output interfaces 440 or other appropriate mechanisms. It is to be appreciated that the illustrated network connections are exemplary and that other means of establishing communication link(s) between the computers 402 and 448 may be employed.

In a networked environment, such as that illustrated with computing environment 400, program modules depicted, relative to the computer 402 or portions thereof, may be stored in a remote memory storage device. By way of example, remote application programs 458 reside on a memory device of remote computer 448. For purposes of illustration, application programs and other executable program components, such as the operating system, are illustrated herein as discrete blocks, although it is recognized that such programs and components reside at various times in different storage components of the computing device 402, and are executed by the data processor(s) of the computer.

Computer-Executable Instructions

An implementation of an exemplary software-product installation facilitation may be described in the general context of computer-executable instructions, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Exemplary Operating Environment

FIG. 4 illustrates an example of a suitable operating environment 400 in which an exemplary software-product installation facilitation may be implemented. Specifically, the exemplary software-product installation facilitation described herein may be implemented (wholly or in part) by any program modules 428-430 and/or operating system 426 in FIG. 4 or a portion thereof.

The operating environment is only an example of a suitable operating environment and is not intended to suggest any limitation as to the scope or use of functionality of the exemplary software-product installation facilitation described herein. Other well known computing systems, environments, and/or configurations that are suitable for use include, but are not limited to, personal computers (PCs), server computers, hand-held or laptop devices, multiprocessor systems, microprocessor-based systems, programmable consumer electronics, wireless phones and equipment, general and special-purpose appliances, application-specific integrated circuits (ASICs), network PCs, minicomputers, mainframe computers, distributed computing environments that include any of the above systems or devices, and the like.

Computer-Readable Media

An implementation of an exemplary software-product installation facilitation may be stored on or transmitted across some form of computer-readable media. Computer-readable media may be any available media that may be accessed by a computer. By way of example, computer-readable media may comprise, but is not limited to, “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

“Communication media” typically embodies computer-readable instructions, data structures, program modules, or other data in a modulated data signal, such as carrier wave or other transport mechanism. Communication media also includes any information delivery media.

Conclusion

The techniques may be implemented in many ways, including (but not limited to) program modules, general- and special-purpose computing systems, network servers and equipment, dedicated electronics and hardware, and as part of one or more computer networks. The techniques may be implemented, for example, on a computer system depicted in FIG. 4.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A software-product installation source embodied on one or more computer-readable media, the source comprising:
one or more installation databases stored on the computer-readable media, the installation databases comprising installation data configured to be loaded onto a computing system when a software product is installed onto that computing system;
one or more executable installation components stored on the computer-readable media, the executable installation components comprising computer-executable instructions that, when executed, directs installation of the software product from the one or more installation databases to the computing system;
wherein the installation data of the one or more installation databases is stored on the computer-readable media in a defined hierarchical directory structure, which includes, at least, a root and one sub-level, the sub-level comprising, at least, two sub-directories comprising:
a first sub-directory comprising one or more installation databases having data for installation of operationally fundamental components of the software product once that product is installed, one or more operationally fundamental components being installed onto the computing system during installation of the software product;
a second sub-directory comprising one or more installation databases having data for installation of installation-customization components of the software product, one or more installation-customization components being installed onto the computing system during installation of the software product in response to selection of one or more installation customization options.

2. A source as recited in claim 1 further comprising one or more installation-information installation components stored on the computer-readable media, the installation-information installation components comprises data regarding the installation databases, the executable installation components, and the defined hierarchical directory structure.

3. A source as recited in claim 1, wherein the one or more executable installation components are stored at the root of the defined hierarchical directory structure of the computer-readable media.

4. A source as recited in claim 1, wherein the sub-level comprising, at least, three sub-directories:
the first sub-directory of operationally fundamental installation databases;
the second sub-directory of installation-customization installation databases configured for customization of an appearance of the operation of the software product once it is installed;
a third sub-directory of installation-customization installation databases configured for adding additional functionality to the operation of the software product once it is installed.

5. A source as recited in claim 1, wherein the computer-readable media is an installation share-point which is accessible by one or more computing systems via a communications network.

6. A source as recited in claim 1, wherein:
the computer-readable media is a single installation share-point which is accessible by one or more computing systems via a communications network;
that share-point having installation bundles of multiple distinct software products cohabitating therein and sharing at least one common executable installation component, an installation bundle of a software product comprising one or more installation databases having data from which the product is installed.

7. A method comprising the act of producing a source, embodied in one or more computer-readable media, as recited in claim 1.

8. A method comprising the acts of:
producing a source, embodied in one or more computer-readable media, as recited in claim 1;
facilitating distribution the produced source.

9. A method comprising the acts of:
producing a source, embodied in one or more computer-readable media, as recited in claim 1;
repeating the producing act for multiple distinct software products, wherein the source produced for each of the multiple distinct software products employs like defined hierarchical directory structure.

10. A method comprising the acts of:
producing a source, embodied in one or more computer-readable media, as recited in claim 1;
repeating the producing act for multiple distinct software products, wherein the source produced for each of the multiple distinct software products employs:
an identical defined hierarchical directory structure;
an identical executable installation component.

11. A method comprising the acts of:
creating a single installation share-point for installation of multiple distinct software products, the share-point being one or more computer-readable media on a computing system, the share-point comprising installation bundles of multiple distinct software products cohabitating therein and sharing at least one common executable installation component;
providing access to the single installation share-point.

12. A method as recited in claim 11Error! Reference source not found., wherein the installation share-point further comprises:
one or more installation databases for each of multiple distinct software products, the databases being stored on the computer-readable media, the installation databases for each of multiple distinct software products, the databases comprising installation data configured to be loaded onto a computing system when a software product is installed onto that computing system;
the common executable installation component being stored on the computer-readable media, the common executable installation component comprising computer-executable instructions that, when executed, directs installation of one or more of multiple distinct software products from the one or more installation databases to the computing system.

13. A method as recited in claim 11Error! Reference source not found., wherein the installation share-point further comprises:
one or more installation databases for each of multiple distinct software products, the databases being stored on the computer-readable media, the installation databases for each of multiple distinct software products, the databases comprising installation data configured to be loaded onto a computing system when a software product is installed onto that computing system;
the common executable installation component being stored on the computer-readable media, the common executable installation component comprising computer-executable instructions that, when executed, directs installation of one or more of multiple distinct software products from the one or more installation databases to the computing system;
wherein the installation data of the one or more installation databases is stored on the computer-readable media in a defined hierarchical directory structure, which includes, at least, a root and one sub-level, the sub-level comprising, at least, two sub-directories comprising:
a first sub-directory comprising one or more installation databases having data for installation of operationally fundamental components of the software product once that product is installed, one or more operationally fundamental components being installed onto the computing system during installation of the software product;
a second sub-directory comprising one or more installation databases having data for installation of installation-customization components of the software product, one or more installation-customization components being installed onto the computing system during installation of the software product in response to selection of one or more installation customization options.

14. A method as recited in claim 11Error! Reference source not found., wherein the installation share-point further comprises:
one or more installation databases for each of multiple distinct software products, the databases being stored on the computer-readable media, the installation databases for each of multiple distinct software products, the databases comprising installation data configured to be loaded onto a computing system when a software product is installed onto that computing system;
the common executable installation component being stored on the computer-readable media, the common executable installation component comprising computer-executable instructions that, when executed, directs installation of one or more of multiple distinct software products from the one or more installation databases to the computing system;
wherein the installation data of the one or more installation databases is stored on the computer-readable media in a defined hierarchical directory structure, which includes, at least, a root and one sub-level, the sub-level comprising, at least, two sub-directories comprising:
a first sub-directory comprising one or more installation databases having data for installation of operationally fundamental components of the software product once that product is installed, one or more operationally fundamental components being installed onto the computing system during installation of the software product;
a second sub-directory comprising one or more installation databases having data for installation of appearance-customization components of the software product, one or more appearance-customization components being installed onto the computing system during installation of the software product in response to selection of one or more appearance customization options;
a third sub-directory comprising one or more installation databases having data for installation of functional-customization components of the software product, one or more functional -customization components being installed onto the computing system during installation of the software product in response to selection of one or more functional customization options.

15. One or more computer-readable media having computer-executable instructions thereon that, when executed by a computer, perform acts comprising:
producing one or more computer-readable media, the media comprising:
one or more installation databases stored on the computer-readable media, the installation databases comprising data configured to be loaded onto a computing system when a software product is installed onto that computing system;
one or more executable installation components stored on the computer-readable media, the executable installation components comprising computer-executable instructions that, when executed, directs installation of the software product by loading data from the one or more installation databases onto the computing system;
organizing the data of one or more installation databases, this data is stored on the computer-readable media in a defined hierarchical directory structure, which includes, at least, a root and one sub-level, the sub-level comprising, at least, two sub-directories comprising:
a first sub-directory comprising one or more installation databases having data for installation of operationally fundamental components of the software product once that product is installed, one or more operationally fundamental components being installed onto the computing system during installation of the software product;
a second sub-directory comprising one or more installation databases having data for installation of installation-customization components of the software product, one or more installation-customization components being installed onto the computing system during installation of the software product in response to selection of one or more installation customization options.

16. One or more computer-readable media as recited in claim 15 further comprising the act of facilitating distribution of the computer-readable media.

17. One or more computer-readable media as recited in claim 15 further comprising the act of repeating the producing and organizing acts for multiple distinct software products, wherein the media produced for each of the multiple distinct software products employs a like defined hierarchical directory structure.

18. One or more computer-readable media as recited in claim 15 further comprising the acts of:
repeating the producing and organizing acts for multiple distinct software products, wherein the media produced for each of the multiple distinct software products employs like defined hierarchical directory structure;
facilitating distribution the computer-readable media for the multiple distinct software products.

19. One or more computer-readable media as recited in claim 15 further comprising the act of repeating the producing and organizing acts for multiple distinct software products, wherein the media produced for each of the multiple distinct software products employs:
an identical defined hierarchical directory structure;
an identical executable installation component

20. One or more computer-readable media as recited in claim 15, wherein the producing act further produces one or more installation-information installation components stored on the computer-readable media, the installation-information installation components comprising data regarding the installation databases, the executable installation components, and the defined hierarchical directory structure.
